(19) United States
(12) Patent Application Publication
(10) Pub. No.: US 2016/0309703 A1
(43) Pub. Date: Oct. 27, 2016

(54) Animated Animal Decoy

(71) Applicant: Samuel E. Meyers, Henderson, KY (US)

(72) Inventor: Samuel E. Meyers, Henderson, KY (US)

(21) Appl. No.: 15/092,985

(22) Filed: Apr. 7, 2016

Related U.S. Application Data
(60) Provisional application No. 62/145,237, filed on Apr. 9, 2015.

(51) Int. Cl. A01M 31/06

(52) U.S. Cl. CPC A01M 31/06

(57) ABSTRACT

An animal decoy generally including a hollow body shell, a head portion, and preferably a sleeve that in application covers or masks a moving head mechanism. The moving head mechanism generally includes an elongated threaded rod, a nut sized to threadably engage the rod, a spring member, and upper and lower plates. In application, the threaded rod is secured to the lower plate, and the lower plate is attached to an upper end of the body. An upper portion of the threaded rod is threadably received within a first end of the spring. The upper plate includes an aperture sized to frictionally receive a second end of the spring. The upper plate is then attached to a lower end of the head portion. There is a spacing within the spring between an upper most end of the rod and the upper plate. The spacing allows the spring to act to wind power, causing the head to similarly act from the force of the wind.

### CROSS REFERENCES TO RELATED APPLICATIONS

U.S. Provisional Application for Patent No. 62/145,237, filed Apr. 9, 2015, with title “Animated Animal Decoy” which is hereby incorporated by reference. Applicant claims priority pursuant to 35 U.S.C. Par. 119(e)(i).

### STATEMENT AS TO RIGHTS TO INVENTIONS MADE UNDER FEDERAL SPONSORED RESEARCH AND DEVELOPMENT

Not Applicable.

### BACKGROUND OF THE INVENTION

1. Field of the Invention

The present invention generally relates to simulated animal decoys used in the sport of hunting.

2. Brief Description of Prior Art

Decoys have long been used by hunters to attract game. In fact, the use of decoys to attract game is an ancient practice. Typically, the hunter will position a number of decoys in a nearby lake or field to attract the game. The existence of these decoys rely on moving parts and having body parts with sizes and shapes that are comparable or equal to the body parts of its live mature animal counterpart.

There have been a number of attempts to meet a primary objective to decoys, and that is to provide a decoy which appears more natural. Attempts have been made to develop decoys with motorized movements which attempt to resemble the natural movements of the game, however, such attempts have mostly fallen short. Other examples of animated decoys have included pendulum motion to stimulate moving parts, which understandably proved to be unlike the real thing. Others have employed an electrical solenoid to cause motion. However, solenoids tend to be noisy and jerky due to the fast pull of the magnetic coil within the solenoids. Still others include noisy mechanisms to stimulate movement wherein the noise scares the animals away rather than attracting them.

As can be seen, there is a continuing need for an animated animal decoy that closely resembles the natural movements of the animal to be hunted.

### SUMMARY OF THE INVENTION

An animal decoy which generally includes a hollow body shell, a head portion, preferably a sleeve that in application covers or masks a moving head mechanism. The moving head mechanism generally includes an elongated threaded rod, a nut sized to threadably engage the rod, a spring member, and upper and lower plates.

In application, the threaded rod is received through a center aperture of the lower plate and secured in place with the nut such that an under surface of the lower plate abuts a head surface of the threaded rod. The lower plate is then appropriately attached to an upper end of the body. The spring includes a first end and a second end and is sized for threadably receiving the threaded rod.

The upper plate includes an aperture sized to frictionally receive the second end of the spring. The second end of the spring is received through the aperture in the upper plate and appropriately secured. The upper plate is then appropriately attached to a lower end surface of the head portion.

A threaded end portion of the rod is received within the first end of the spring, the rod being attached to the lower plate that is attached to the body as disclosed; and the second end of the spring is attached to the upper plate that is attached to the head as disclosed. There is a spacing within the spring between the upper most end of the rod and the upper plate. The spacing allows the spring member to act to wind power, causing the head to similarly act from the force of the wind.

The decoy device may further include a sleeve member disposed between the head portion and the body. The sleeve member for masking or covering the defined moving head mechanism.

### BRIEF DESCRIPTION OF THE DRAWINGS

FIG. 1 is a side view of a preferred embodiment of the present invention, an animated animal decoy, with the sleeve portion illustrated so that you can also view the moving head mechanism within.

FIG. 2 is an exploded view of the animated animal decoy of FIG. 1.

FIG. 3 is an exploded view of the moving head mechanism of the present invention.

### DESCRIPTION OF THE PREFERRED EMBODIMENT

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The animated animal decoy of the present invention is directed to an animal decoy which mimics animal movement. More particularly, the animated animal decoy of the present invention includes a decoy body depicting a live mature animal. The decoy will further have colors thereon mimicking the colors of the live mature animal. The decoy will include a moving head depicting the natural movement of the animal. As will be discussed, the animated animal decoy as disclosed consists of components configured and correlated with respect to each other so as to attain the desired objective.

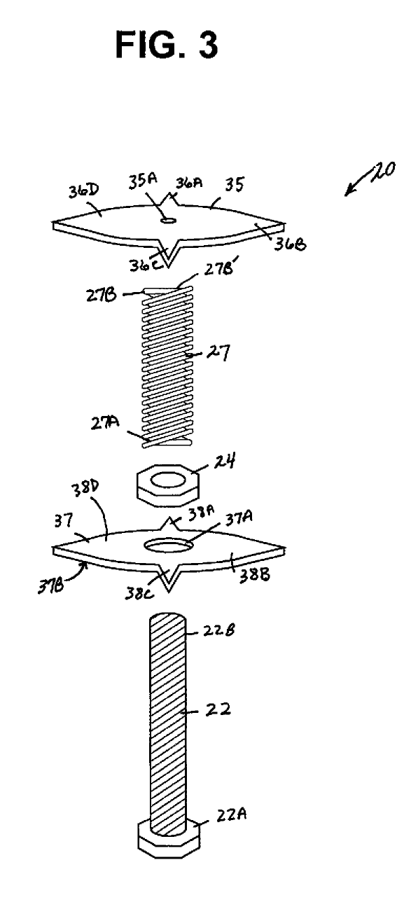

In accordance with the present invention, there is provided an animal decoy 10 which includes a moving head mechanism generally designated as numeral 20 (best shown in FIG. 3). The animal decoy 10 comprises a hollow body shell 12, the head portion 15, and preferably a sleeve 17 that in application covers or masks the head mechanism 20.

The moving head mechanism of the present invention generally includes an elongated threaded rod 22, a nut 24 sized to threadably engage the rod 22, a spring member 27, an upper plate 35 and a lower plate 37, working together to achieve the desired results.

As illustrated, the threaded rod 22 extends upwardly from the body 12. More particularly, the threaded rod 22 is preferably received through a center aperture 37A of the lower plate 37. The aperture 37A sized to frictionally receive the rod 22. The nut 24 is threadably received on the rod 22 and tightened such that an under surface 37B of the lower plate 37 abuts a head surface 22A of the threaded rod 22.

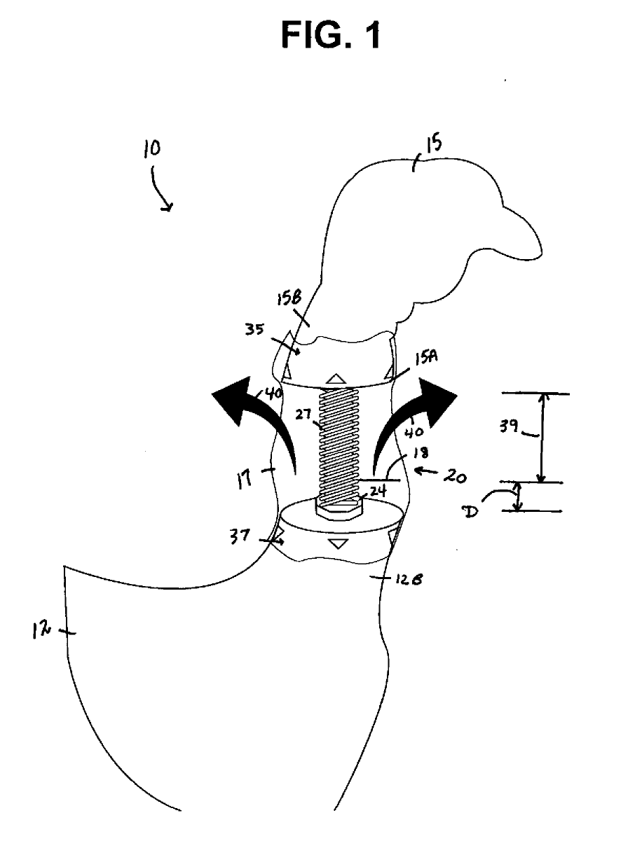

The lower plate 37 has a generally star polygon shape with a plurality of defined points. The present illustration shows the plate 37 having four (4) points 38A, 38B, 38C, 38D. Preferably, the lower plate 37 is constructed of a soft metal material such as a stainless steel material such that in application, the lower plate 37 rests on an upper end 12A of the body 12 and the points 38A, 38B, 38C, 38D, are downwardly urged until the points are in contact with the outer surface 12B of the body 12 as best shown in FIG. 1, thereby releaseably attaching the lower plate 37 to the body 12.

Alternatively, it is anticipated that the upper end 12A may include an aperture (not shown) sized to receive the rod 22 where the rod 22 would upwardly pass through the aperture and tightened in place with the nut 24, with the nut 24 being outside the body 12 and the head surface 22A being within the hollow body shell 12.

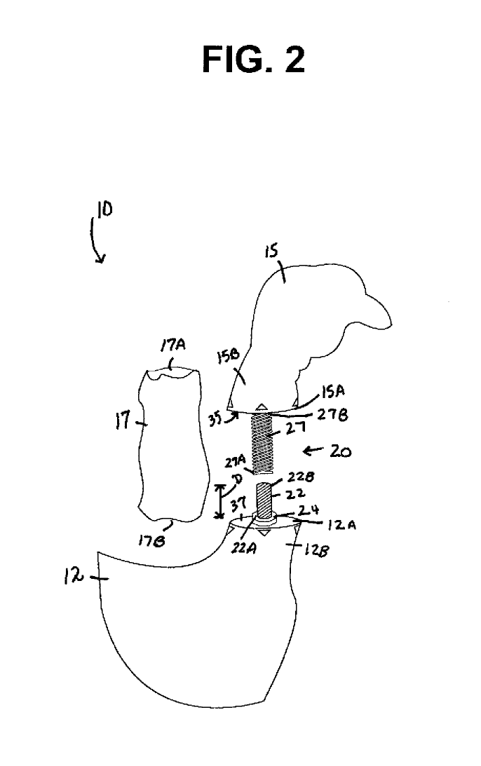

As will be understood, it is important that an end portion 22B of the rod 22, opposite the head surface 22A upwardly extend a distance D (see FIG. 2) from the upper surface 12A. The Applicant has found an acceptable distance D to be about one-half (½) inches.

The spring 27 includes a first end 27A and a second end 27B. The spring 27 having an inner diameter sized for threadably receiving the threaded rod 22. In particular, the end portion 22B of the rod 22 is threadably received within the first end 27A of the spring 27.

As known, the spring member 27 is generally constructed of a metal wire or metal band. The upper plate 35 includes an aperture 35A sized to frictionally receive the second end 27B of the spring 27. In application, an upper most end 27B′ (wire band) of the second end 27B of the spring 27 is received through the aperture 35A and the end 27B′ is preferably bent or twisted (not shown) to prevent the second end 27B from returning through the aperture 35A and separating from the upper plate 35.

Like the lower plate 37, the upper plate 35 has a generally star polygon shape with a plurality of defined points. The present illustration shows plate 37 having four (4) points 36A, 36B, 36C, 36D. Preferably the upper plate 35 is constructed of a soft metal material such as a stainless steel material or aluminum material such that in application the upper plate 35 rests on a lower end 15A of the head portion 15 and the points 36A, 36B, 36C, 36D, are upwardly urged until the points are in contact with the outer surface 15B of the head 15 as best shown in FIG. 1, thereby releaseably attaching the upper plate 35 to the head portion 15.

In application, the end portion 22B of the rod 22 is received within the first end 27A of the spring 27, and the second end 27B of the spring 27 is attached to the upper plate 35, and the plate 35 attached to the head 15 as disclosed.

Referring to FIG. 1, line 18 illustrates the approximate location of the upper most end of the rod 22 within spring 27. The distance between line 18 and the lower plate 37 is preferably about one-half (½) inches (distance D as defined). As such, there is a spacing 39 within the spring 27 between the upper most rod end (line 18) and the upper plate 35. The spacing 39 allows the spring member 27 to act to wind power 40, causing the head 15 to similarly act from the force of the wind 40. Preferably, the spacing is about one (1) inches in length.

It should be understood, that the shorter the spring and therefore the lesser the spacing 39, the tighter the spring tension. And, it should be further understood that the length of the spring can be selected by the amount of the end 27B′ of the spring 27 is received through the aperture 35A.

The decoy 10 may further include the sleeve 17 that is disposed between the head 15 and the body 12. The sleeve 17 includes a first end opening 17A that is in communications with the head 15 that preferably at least cover the lower end 15A of the head 15, and a second end opening 17B that is in communications with the body 12 that preferably at least covers the upper end 12A.

The foregoing detailed description is given primarily for clearness of understanding and no unnecessary limitations are to be understood therefrom, for modification will become obvious skilled in the art upon reading this disclosure and be made upon departing from the spirit of the invention and scope of the appended claims. For example, the application of the present invention is not intended for any particular game. While the drawings depict a turkey decoy, the present invention applies to any other game animal that is hunted.

Accordingly, this invention is not intended to be limited by the specific exemplification presented herein above. Rather, what is intended to be covered is within the spirit and scope of the appended claims.

I claim:

1. An animal decoy comprising:
a hollow body shell,
a head portion,
a moving head mechanism disposed between said hollow body shell and said head portion including an elongated threaded rod that vertically extends from an upper end of said hollow body shell, a spring member having an inner diameter sized to threadably receive said rod such that a distance of an upper end of said rod is threadably received within a lower end of said spring member, and an upper end of said spring member is attached to a lower end of the head portion, and
wherein a spacing is defined within said spring member between an upper most end of said threaded rod and said lower end of the head portion.

2. The decoy device of claim 1, wherein said distance is about one-half (½) inches.

3. The decoy device of claim 1, further including a sleeve member configured for covering said moving head mechanism.

4. The decoy device of claim 1, wherein said moving head mechanism further including an upper plate having an aperture sized to frictionally receive said upper end of said spring, and said upper plate having a polygon configuration with a plurality of defined points, and said upper plate configured to rest on said lower end of the head portion and said plurality of defined points of said upper plate each configured to be upwardly urged until each of said plurality of defined points of said upper plate are in contact with an outer surface of the head portion.

5. The decoy device of claim 1, wherein said threaded rod vertically extends from a lower plate, said lower plate having a polygon configuration with a plurality of defined points, said lower plate configured to rest on said upper end of said hollow body shell and said plurality of defined points on said lower plate each configured to be downwardly urged until each of the plurality of defined points of the lower plate are in contact with an outer surface of said body shell.

6. The decoy device of claim 4, wherein said upper plate is constructed of a soft metal material.

7. The decoy device of claim 5, wherein said lower plate is constructed of a soft metal material.

8. An animal decoy comprising:
a hollow body shell,
a head portion,
a moving head mechanism including an elongated threaded rod, a nut sized to threadably engage the rod, a spring member having an inner diameter sized to threadably receive an upper end of said rod, and wherein said rod is secured to an upper end of said body shell, and a portion of an upper end of said rod is threadably received within a lower end of said spring member, and an upper end of said spring member is attached to a lower end of the head portion, and
wherein a spacing is defined within said spring member between an upper most end of said threaded rod and said lower end of the head portion.

9. The decoy device of claim 8, wherein said portion defines a distance of about one-half (½) inches.

10. The decoy device of claim 9, wherein said spacing having a length of about one (1) inches.

11. The decoy device of claim 10, further including a sleeve member disposed between said head portion and said body shell, said sleeve member configured for covering said moving head mechanism.

12. The decoy device of claim 11, wherein said moving head mechanism further including an upper plate having an aperture sized to frictionally receive said upper end of said spring, and said upper plate having a polygon configuration with a plurality of defined points, and said upper plate configured to rest on said lower end of the head portion and said plurality of defined points of said upper plate each configured to be upwardly urged until each of the plurality of defined points of said upper plate are in contact with an outer surface of the head portion.

13. The decoy of claim 11, wherein said threaded rod is secured to a lower plate with said nut such that an under surface of the lower plate abuts a head surface of the threaded rod and said lower plate having a polygon configuration with a plurality of defined points, said lower plate configured to rest on said upper end of said hollow body shell and said plurality of defined points on said lower plate each configured to be downwardly urged until each of said plurality of defined points of the lower plate are in contact with an outer surface of said body shell.

14. An animal decoy comprising:
a hollow body shell,
a head portion,
a sleeve configured for covering a moving head mechanism, said moving head mechanism including an elongated threaded rod, a nut sized to threadably engage said rod, a spring member, and upper and lower plates, said spring member having an inner diameter sized to threadably receive an upper end of said rod,
said upper plate including an aperture sized to frictionally receive an upper end of the spring, and said upper plate having a polygon configuration with four defined points, and said upper plate configured to rest on a lower end surface of the head portion and said four defined points of said upper plate each configured to be upwardly urged until each of the four defined points of said upper plate are in contact with an outer surface of the head portion,
said lower plate including an aperture sized to receive said threaded rod and said nut threadably secures the threaded rod to the lower plate such that an under surface of the lower plate abuts a head surface of the threaded rod, said lower plate having a polygon shape with four defined points, said lower plate configured to rest on an upper surface of said hollow body shell and said four defined points of said lower plate each configured to be downwardly urged until each of the four defined points of the lower plate are in contact with an outer surface of said body shell,
wherein an upper portion of said threaded rod upwardly extends a distance from from the lower plate, and
wherein a spacing is defined within said spring member between an upper most end of said threaded rod and the upper plate.

15. The decoy device of claim 14, wherein said distance is about one-half (½) inches.

16. The decoy device of claim 15, wherein said spacing having a length of about one (1) inches.

17. The decoy device of claim 14, wherein said upper and lower plates are constructed of a soft metal material.

18. The decoy device of claim 17, wherein said soft metal is aluminum.

19. The decoy device of claim 17, wherein said soft metal is stainless steel.
